(19) United States
(12) Patent Application Publication
(10) Pub. No.: US 2021/0056406 A1
(43) Pub. Date: Feb. 25, 2021

(54) LOCALIZED METAL LOSS ESTIMATION ACROSS PIPING STRUCTURE

(71) Applicant: Saudi Arabia Oil Company, Dhahran (SA)

(72) Inventors: Ahmad Aldabbagh, Thuwal (SA); Sahejad Patel, Thuwal (SA); Hassane Trigui, Thuwal (SA)

(21) Appl. No.: 16/548,399

(22) Filed: Aug. 22, 2019

(51) Int. Cl. G06N 3/08; G06K 9/62; G06F 17/50; G06T 17/10

(52) U.S. Cl. CPC G06N 3/08; G06T 17/10; G06F 17/5009; G06K 9/6256

(57) ABSTRACT

A method according to the disclosure configures a processor to execute a machine learning model specific to a type and size of the structure, the machine learning model being trained using historical data of known structures of the same type and size to predict an amount of metal lost by the structure over time. The method predicts metal loss over sections of a specimen structure using the trained machine learning model and generates a three-dimensional visualization of the specimen structure including an overlay depicting predicted metal loss over the sections of the structure at the time of prediction. The historical data upon which prediction of an amount of metal lost is based includes: spatial maps of measured wall thicknesses over time, material composition, operating conditions for structures of the same type and size, or a combination of the foregoing. In certain embodiments, the structure is a pipe component.

### FIELD OF THE DISCLOSURE

The present disclosure concerns predictive methods for assessing the condition of structures, and, more particularly, relates to a method of estimating localized metal loss in pipe structures, particularly those used in the oil and gas industry.

### BACKGROUND OF THE DISCLOSURE

Infrastructure corrosion is a significant problem faced by the oil and gas industry. Structures such as pipes and tanks are subject to corrosion over time due to the accumulation of moisture and to exposure to the hydrocarbon flows which they carry. Typically, this problem has been addressed by periodic inspections of infrastructure installations by field personnel. This process is time consuming in that it requires the structures to be placed offline, and for coverings and insulation on the structures to be removed to inspect the underlying metallic components. In addition, since infrastructure installations are so large and widespread, only a fraction of the structures can be manually inspected in this manner at any one time. To optimize resources, areas deemed to be of higher risk receive more attention from inspectors. However, the predetermination as to which structures are at highest risk is subject to error.

Recently, automated non-invasive techniques for detecting structural corrosion have been developed. In one such technique, described in commonly-owned U.S. patent application Ser. No. 16/117,937, entitled “Cloud-Based Machine Learning System and Data Fusion for the Prediction of Corrosion Under Insulation,” infrared thermal imaging is used to detect corrosion. A thermal imaging device can be coupled to a robotic device that can cover large spans of infrastructure, dispensing with the need for manual inspection. Such techniques have provided data about rates of corrosion of different types of structures in a variety of situations.

### SUMMARY OF THE DISCLOSURE

Embodiments of the present disclosure provide a method for predicting and visualizing metal loss in a structure. The method comprises configuring a processor to: execute a machine learning model specific to a type and size of the structure, the machine learning model being trained using historical data of known structures of the same type and size to predict an amount of metal lost by the structure over time; predict the metal loss over sections of a specimen structure at a time of prediction using the trained machine learning model; and generate a three-dimensional visualization of the specimen structure including an overlay depicting predicted metal loss over the sections of the structure at the time of prediction. The historical data upon which prediction of the amount of metal lost is based includes: spatial maps of measured wall thicknesses over time, material composition, operating conditions for structures of the same type and size, or a combination of the foregoing. In embodiments of the present disclosure, the structure is a pipe component.

In certain implementations, the operating conditions include a time series of temperature, a pressure and a flow rate data of one or more fluids transported through the structure.

In certain implementations, the historical data upon which prediction of an amount of metal lost is based further includes: coating composition, products transported, date of installation, location of installation, ambient conditions at the location of installation, or a combination of the foregoing. The ambient conditions can include a time series of temperature and humidity data at the location of installation.

Embodiments of the method further comprise configuring a processor to receive a measurement of actual metal loss in a specimen structure having the same type and size as the structure for which the prediction of metal loss is made, compare the measured metal loss to the predicted metal loss, and correct the machine learning model based on a magnitude of a difference between the measured and predicted metal loss.

Embodiments of the present disclosure also provide a method for predicting and visualizing metal loss in a plurality of structures. The method comprises configuring a processor with program code to: execute a plurality of machine learning models for specific structure types and sizes, each of the plurality of machine learning models being trained using historical data of known structures of the same type and size to predict an amount of metal lost by each of the structure types and sizes over time; predict the metal loss over sections of a specimen structure of a specific type and size at a time of prediction using the trained machine learning model adapted for the type and size of the specimen structure; and generate a three-dimensional visualization of the specimen structure including an overlay depicting predicted metal loss over the sections of the structure at the time of prediction. The historical data upon which prediction of the amount of metal lost is based includes spatial maps of measured wall thicknesses over time, material composition, operating conditions for structures of the same type and size, or a combination of the foregoing. In embodiments of the present disclosure, the plurality of structures are pipe components.

In certain implementations, the operating conditions include a time series of temperature, a pressure and a flow rate data of one or more fluids transported through the plurality of structures.

In certain implementations, the historical data upon which prediction of the amount of metal lost is based further includes: coating composition, products transported, location of installation, date of installation, ambient conditions at the location of installation, or a combination of the foregoing. The ambient conditions can include a time series of temperature and humidity data at the location of installation.

Embodiments of the method can further comprise causing a processor to receive measurements of actual metal loss in specimen structures having the same type and size as the plurality of structure for which a prediction of metal loss is made, compare the measured metal loss to the predicted metal loss in each case, and correct the machine learning model based on a magnitude of differences between the measured and predicted metal loss from each comparison.

The present disclosure also provides a non-transitory computer-readable medium comprising instructions which, when executed by a computer system, cause the computer system to carry out a method of predicting and visualizing metal loss in a structure including steps of: executing a machine learning model specific to a type and size of the structure, the machine learning model being trained using historical data of known structures of the same type and size to predict an amount of metal lost by the structure over time; predicting the metal loss over sections of a specimen structure at a time of prediction using the trained machine learning model; and generating a three-dimensional visualization of the specimen structure including an overlay depicting predicted metal loss over the sections of the structure at the time of prediction. The historical data upon which prediction of the amount of metal lost is based includes spatial maps of measured wall thicknesses over time, material composition, operating conditions for structures of the same type and size, or a combination of the foregoing.

In certain implementations, the operating conditions include a time series of temperature, a pressure and a flow rate data of one or more fluids transported through the structure. The historical data upon which prediction of the amount of metal lost is based can further include coating composition, products transported, date of installation, location of installation, ambient conditions at the location of installation, or a combination of the foregoing. The ambient conditions can include a time series of temperature and humidity data at the location of installation.

In certain implementations, the non-transitory computer-readable medium further includes instructions which, when executed by a computer system, cause the computer system to carry out the steps of receiving a measurement of actual metal loss of specimen structures having the same type and size as the plurality of structure for which a prediction of metal loss is made, comparing the measured metal loss to the predicted metal loss in each case, and correcting the machine learning model based on a magnitude of differences between the measured and predicted metal loss from each comparison.

These and other aspects, features, and advantages can be appreciated from the following description of certain embodiments of the invention and the accompanying drawing figures and claims.

### BRIEF DESCRIPTION OF THE DRAWINGS

FIG. 1 is a schematic flow diagram of a system and method for training a model to determine metal loss from historical data according an embodiment of the present disclosure.

FIG. 2 is a schematic block diagram of a computing device that can be configured to perform the training and testing procedures for determining metal loss according to the present disclosure.

FIG. 3 is schematic diagram of a process for testing a model for determining metal loss according to an embodiment of the present disclosure.

FIG. 4 is a perspective view of an example visualization of a pipe component with an overly depicting metal loss according to an embodiment of the present disclosure.

### DETAILED DESCRIPTION OF CERTAIN EMBODIMENTS OF THE DISCLOSURE

Disclosed herein is a method for predicting metal loss in infrastructural components including pipe structures based on historical data, and from the prediction, creating a visual map indicating the expected integrity of the assets. In certain embodiments of the method, a plurality of machine learning models for different structural categories are trained using historical data. The machine learning models can be validated by field inspection and/or non-invasive field monitoring techniques. Quantification of any errors in the machine learning model ascertained during the validation phase can be used as factors in correcting and adding robustness to the machine learning model.

In part, data gathered, for instance, as described in the aforementioned U.S. patent application Ser. No. 16/117,937 to develop an accurate model of corrosion from which an accurate prediction as to how much corrosion has accumulated, or, equally, how much metal has been lost, in a particular structure over time. The ability to provide such an accurate prediction enables visualization of where facilities and equipment are at a highest risk as compared to locations in which there is no corrosion or less corrosion accumulation, and can further enable rapid and efficient replacement of damaged equipment. The present disclosure provides a predictive model of metal loss in pipe structures which enables such visualization of high-risk facilities and structures and associated remediation to maintain the quality of oil and gas infrastructure.

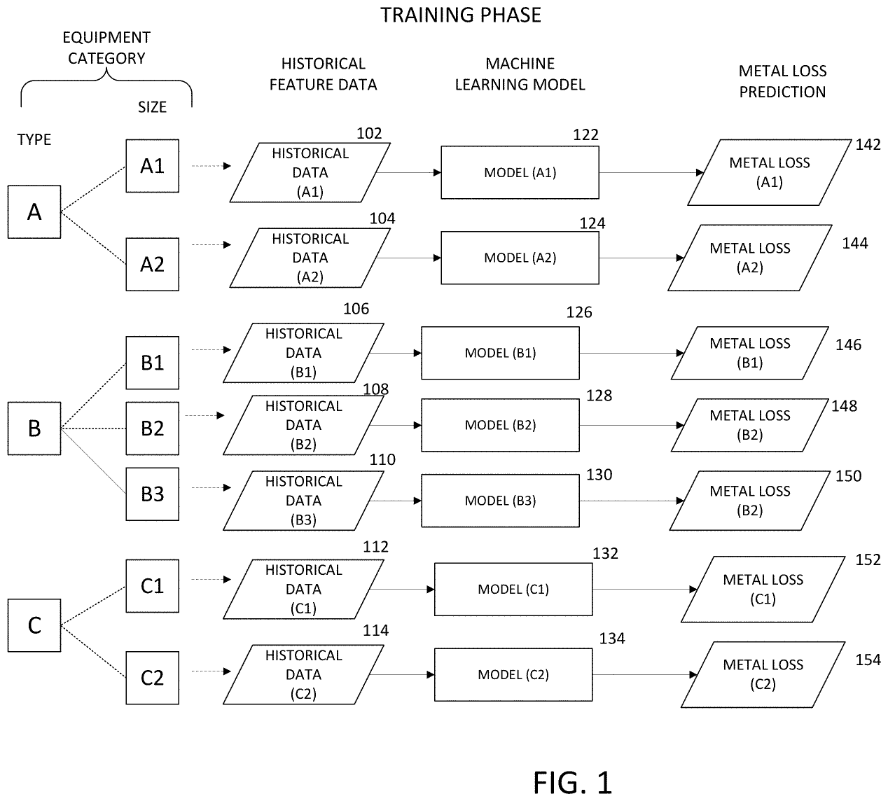

FIG. 1 is a schematic flow diagram of a system and method for training a model to determine metal loss from historical data according an embodiment of the present disclosure. In the system, components of piping infrastructure are categorized by type and size. In the example shown in FIG. 1, three distinct component types A, B and C are shown for ease of illustration. Component types A, B and C can be any one of, without limitation, pipe tubing, elbows, fittings, flanges, welded joints, and gaskets, among other component types. Each component type can have one or more standard or custom sizes. In the example shown in FIG. 1, component type A has two different sizes, A1 and A2; component type B has three sizes B1, B2 and B3; and component C has two sizes C1 and C2.

For each of the component type-size combinations, detailed historical data regarding the condition of components of the pertinent type/size installed in the field are acquired and compiled. As depicted, blocks representing historical data (A1) 102, historical data (A2) 104, historical data (B1) 106, historical data (B2) 108, historical data (B3) 110, historical data (C1) 112, and historical data (C2) 114 are shown. The historical data for each of the type-size combinations includes The dates of installation, spatial maps of wall thickness measurements over time, the types of material from which the components (structures) are made (such as the type of steel), the types of coating(s) used on the components, operating conditions of the material which the pipes transport including temperature, pressure and flow rate (among others), the products transported through the components (such as gas, refined hydrocarbons and water), ambient conditions over time including temperature and humidity at the location at which the structures are installed, the location of the components (above ground or underground), and the time/date at which the data regarding the components were collected.

For historical data for each type/size combination is fed into a training model specific to the combination. More specifically, historical data (A1) 102 is input to training model (A1) 122, historical data (A2) 104 is input to training model (A2) 124, historical data (B1) is input to training model (B1) 126, historical data (B2) is input to training model (B2) 128, historical data (B3) 110 is input to training model (B3) 130, historical data (C1) is input to training model (C1) 132, and historical data (C2) is input to training model (C2) 134. Training models 122-134 are designed to determine, at a certain time of prediction, the amount of metal loss a particular component has sustained, based on knowledge of how similar components have behaved (and suffered from metal loss) over time. Training models 122-134 can be any one of a wide range of machine learning algorithms that are used to determine a quantity (as opposed to determining a classification) such as but not limited to linear regression, generalized linear models (GLM), support vector regression (SVR), gaussian process regression (GPR), decision trees, a Boltzmann machine, a Gabor filter, and neural networks including an artificial neural network (ANN), a deep neural network (DNN), a recurrent neural network (RNN), a stacked RNN, a convolutional neural network (CNN), a deep CNN (DCNN), and a deep belief neural network (DBN), and other supervised learning technologies. The training models 122-134 can utilize the same type of algorithm, or different algorithms can be used for different type/size combinations.

The training models use all of the time series historical data, including numerous different features and parameters to estimate a rate at which metal is eroded or otherwise lost from the different pipe components. From the estimated metal loss rate, a prediction of metal loss at a given future time of prediction can be extrapolated. For instance, if upon execution of the training model 128 it is determined that that component B2 suffers metal loss at the rate of 2 cubic millimeters per month and the metal loss of a specific component is 14 cubic millimeters as of the end of 2017, then if the time of prediction is the end of 2019, the model extrapolates a loss of approximately 14+2*24 (months)=62 cubic millimeters, adjusted for various factors including changes to the metal loss rate based on ambient, operational and other factors. Returning to FIG. 1, the output of each of the training models 122-134 is an associated metal loss prediction. More specifically, the output of training model (A1) 122 is metal loss prediction (A1) 142, the output of training model (A2) 124 is metal loss prediction (A2) 144, the output of training model (B1) 126 is metal loss prediction (B1) 146, the output of training model (B2) 128 is metal loss prediction (B2) 148, the output of training model (B3) 130 is metal loss prediction (B3) 150, the output of training model (C1) 132 is metal loss prediction (C1) 152 and the output of training model (C2) is metal loss prediction (C2) 152.

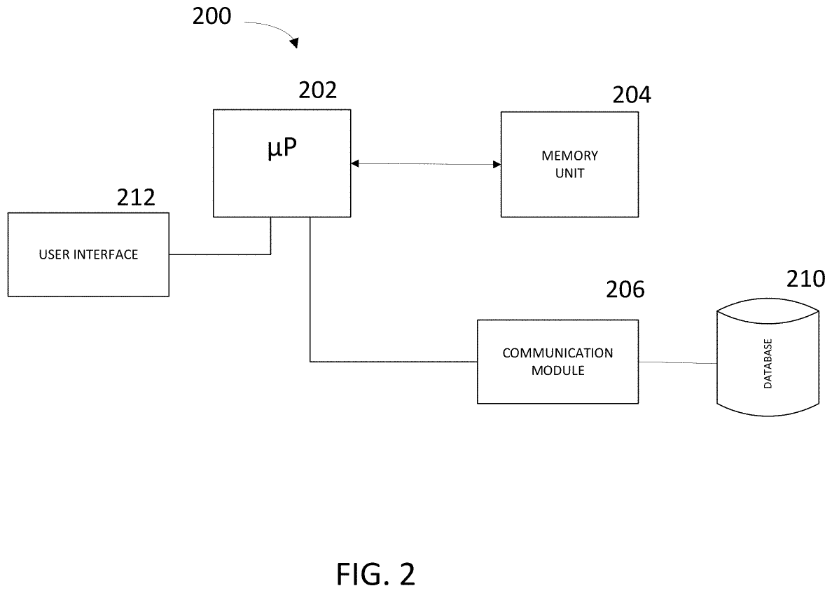

FIG. 2 is a schematic block diagram of a computing device that can execute a method for training a model to determine metal loss from historical data according an embodiment of the present disclosure. The computer device 200 includes a processor 202, a memory unit 204 coupled to the processor, and a communication module 206 which can include a transceiver and associated components for sending and receiving signals (over a wired or wireless medium) from and into the computing device. The communication module 206 is also coupled to the processor 202. Memory unit 204 can include local cache memory, random-access memory (RAM), read-only memory, or other types of memory that can be readily accessed by the processor 202. Contents of the memory unit 204 can include programmed instructions that enable the processor to execute the training method described above. In other implementations, the programmed instructions can be received remotely via the communication module 206. The historical data which the training method uses can be stored remotely on one more accessible databases collectively represented by database 210, which the processor can access via communication module 206. The computing device 200 also includes a user interface 212 through which users can enter data and view displayed data.

After the models 122-134 (shown in FIG. 1) have been trained using the available historical data, the models are tested using field data. Field technical personal invasively or non-invasively inspect samples of pipe components in the field, determine the actual metal loss incurred by the samples. This information can be input to a computing system to compare the actual metal loss with metal loss predictions generated by the models with respect to the same component type/size as those sampled.

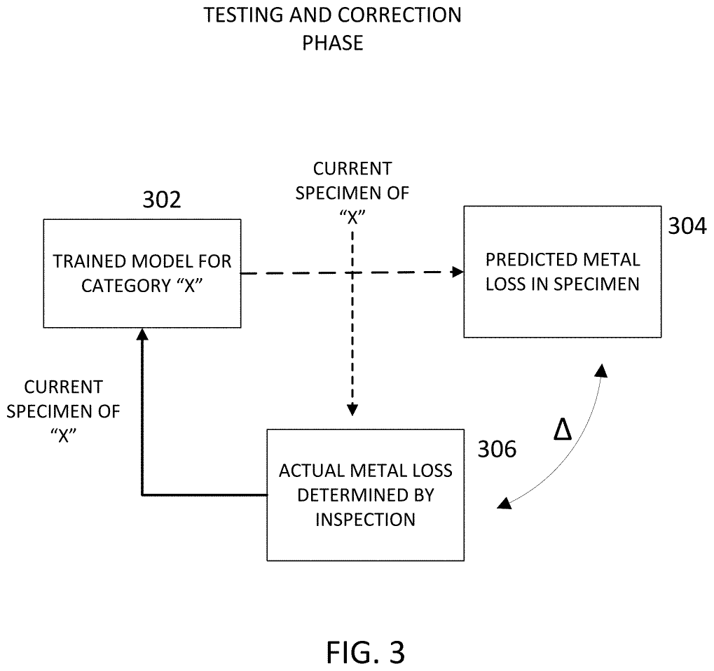

FIG. 3 is a schematic diagram showing a model testing process according to the present disclosure. In FIG. 3, a model 302 generates a metal loss prediction 304 for a specific component type/size having a representative example in the field. Field engineers determine the actual metal loss 306 of the representative example. Typically, there is some difference (Δ) between the actual and predicted metal loss. Importantly, the magnitude of Δ is input back to the model 302 to help retrain the model with the aim of reducing the magnitude of Δ; that is, the model algorithm recomputes the weights of various of the factors so as to bring the metal loss prediction closer to the actual metal loss value obtained in the field. This process is repeated over numerous samples for as many component type/size combinations as possible to obtain a sufficiently large testing data set. In operation, users input the actual metal loss values into the computer device which is configured to execute the model algorithms in a supervised manner. The weightings of the models are adjusted by a backward propagation process based on the known metal loss values to improve the accuracy of the models.

Once a model of any type-size combination has been trained and tested, the computing device that executes the model can also be configured to display a dashboard the hosts a three-dimensional simulation of facilities, plants and their related assets. The three-dimensional simulation displays the assets such as pipe structures (with zoom-in, zoom-out capability). On or adjacent to each structure in the simulation, an overlay can be displayed which indicates the predicted metal loss of the structure as a function of time. Additionally, the simulation includes functionality allowing an operator to select a plant or facility, and once a plant is selected to generate a three-dimensional simulation of the selected facility. Each component in the facility (i.e. assets, pipelines, etc.) can be selected by the operator. Upon selection, the computing device is configured to generate and display a heat map with the predicted thickness for all x, y, and z coordinates of the selected component. These predictions are generated in real time using the trained and tested model.

Using such simulations, the operator can generate heat maps of any section or an entire facility to identify the areas with that require immediate remediation, for instance, because the heat map indicates a high likelihood of failure due to metal loss (such as greater than 20% chance of failure over the next year being a “high” likelihood). The simulations enable operators to target areas of higher risk of failure efficiently instead of by random spot checks of locations during periodic inspections.

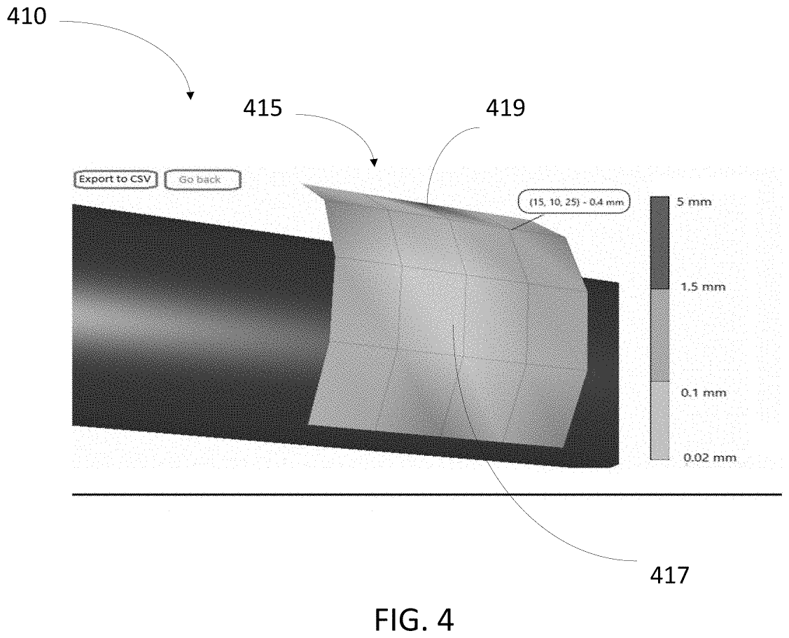

FIG. 4 is an example illustration of a heat map generated for a pipe component according to the present disclosure. The heat map can be generated on a computing device configured with software for rendering three-dimensional images using the data obtained from executing one or more of the machine learning models described above. In FIG. 4, a component 410 is illustrated with an overlay 415 which is configured to appear when the operator hovers over a section of the component using an interface device (such as a mouse or touch screen, as known in the art). The overlay shows expected levels of metal loss at the coordinates of the component section. The area of component encompassed in the overlay is a parameter that can be set by the operator. As shown in the figure with reference to the legend to the right, the overlay displays variations in the amount of expected metal loss at different coordinates within the covered section. For example, the middle of the overlay 415 shows an area with low expected metal loss 417 (about 0.02 mm to about 0.1 mm of expected metal loss), while the top of the overlay displays an area with a considerably higher expected metal loss 419 (about 1.5 mm to about 5 mm of expected metal loss).

The method of determining and visualizing metal loss in pipe structures is considerably more accurate than conventional approaches because the algorithmic models take into account various parameters such as geometrical shape of the structure and operating conditions to provide a better estimation of the remaining wall thickness.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and “comprising”, when used in this specification, specify the presence of stated features, integers, steps, operations, elements, or components, but do not preclude the presence or addition of one or more other features, integers, steps, operations, elements, components, or groups thereof.

Terms of orientation are used herein merely for purposes of convention and referencing, and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method for predicting and visualizing metal loss in a structure comprising:
configuring a processor to:
execute a machine learning model specific to a type and size of the structure, the machine learning model being trained using historical data of known structures of the same type and size to predict an amount of metal lost by the structure over time;
predict the metal loss over sections of a specimen structure at a time of prediction using the trained machine learning model; and
generate a three-dimensional visualization of the specimen structure including an overlay depicting predicted metal loss over the sections of the structure at the time of prediction,
wherein the historical data upon which prediction of the amount of metal lost is based includes: spatial maps of measured wall thicknesses over time, material composition, operating conditions for structures of the same type and size, or a combination of the foregoing.

2. The method of claim 1, wherein the structure is a pipe component.

3. The method of claim 1, wherein the operating conditions include: a time series of temperature, a pressure, a flow rate data of one or more fluids transported through the structure, or a combination of the foregoing.

4. The method of claim 1, wherein the historical data upon which prediction of the amount of metal lost is based further includes: coating composition, products transported, date of installation, location of installation, ambient conditions at the location of installation, or a combination of the foregoing.

5. The method of claim 4, wherein the ambient conditions include a time series of temperature and humidity data at the location of installation.

6. The method of claim 1, further comprising configuring a processor to:
receive a measurement of actual metal loss in a specimen structure having the same type and size as the structure for which the prediction of metal loss is made;
compare the measured metal loss to the predicted metal loss; and
correct the machine learning model based on a magnitude of a difference between the measured and predicted metal loss.

7. A method for predicting and visualizing metal loss in a plurality of structures comprising:
configuring a processor with program code to:
execute a plurality of machine learning models for specific structure types and sizes, each of the plurality of machine learning models being trained using historical data of known structures of the same type and size to predict an amount of metal lost by each of the structure types and sizes over time;
predict the metal loss over sections of a specimen structure of a specific type and size at a time of prediction using the trained machine learning model adapted for the type and size of the specimen structure; and
generate a three-dimensional visualization of the specimen structure including an overlay depicting predicted metal loss over the sections of the structure at the time of prediction;
wherein the historical data upon which prediction of the amount of metal lost is based includes: spatial maps of measured wall thicknesses over time, material composition, operating conditions for structures of the same type and size, or a combination of the foregoing.

8. The method of claim 7, wherein the plurality of structures are pipe components.

9. The method of claim 7, wherein the operating conditions include: a time series of temperature, a pressure, a flow rate data of one or more fluids transported through the plurality of structures, or a combination of the foregoing.

10. The method of claim 7, wherein the historical data upon which prediction of an amount of metal lost is based further includes: coating composition, products transported, location of installation, date of installation, ambient conditions at the location of installation, or a combination of the foregoing.

11. The method of claim 10, wherein the ambient conditions include a time series of temperature and humidity data at the location of installation.

12. The method of claim 7, further comprising causing a processor to:
receive measurements of actual metal loss in specimen structures having the same type and size as the plurality of structure for which a prediction of metal loss is made;
compare the measured metal loss to the predicted metal loss in each case; and
correct the machine learning model based on a magnitude of differences between the measured and predicted metal loss from each comparison.

13. A non-transitory computer-readable medium comprising instructions which, when executed by a computer system, cause the computer system to carry out a method of predicting and visualizing metal loss in a structure including steps of:
executing a machine learning model specific to a type and size of the structure, the machine learning model being trained using historical data of known structures of the same type and size to predict an amount of metal lost by the structure over time;
predicting the metal loss over sections of a specimen structure at a time of prediction using the trained machine learning model; and
generating a three-dimensional visualization of the specimen structure including an overlay depicting predicted metal loss over the sections of the structure at the time of prediction;
wherein the historical data upon which prediction of the amount of metal lost is based includes: spatial maps of measured wall thicknesses over time, material composition, operating conditions for structures of the same type and size, or a combination of the foregoing.

14. The non-transitory computer-readable medium of claim 13, wherein the operating conditions include: a time series of temperature, a pressure, a flow rate data of one or more fluids transported through the structure, or a combination of the foregoing.

15. The non-transitory computer-readable medium of claim 13, wherein the historical data upon which prediction of the amount of metal lost is based further includes: coating composition, products transported, date of installation, location of installation, ambient conditions at the location of installation, or a combination of the foregoing.

16. The non-transitory computer-readable medium of claim 15, wherein the ambient conditions include a time series of temperature and humidity data at the location of installation.

17. The non-transitory computer-readable medium of claim 13, further including instructions which, when executed by a computer system, cause the computer system to carry out the following steps:
receiving a measurement of actual metal loss of specimen structures having the same type and size as the plurality of structure for which a prediction of metal loss is made;
comparing the measured metal loss to the predicted metal loss in each case; and
correcting the machine learning model based on a magnitude of differences between the measured and predicted metal loss from each comparison.
